(19) United States
(12) Patent Application Publication
(10) Pub. No.: US 2026/0094391 A1
(43) Pub. Date: Apr. 2, 2026

(54) PRESENTING VIEWS AND/OR REPRESENTATIONS OF OBJECTS IN A THREE-DIMENSIONAL ENVIRONMENT

(71) Applicant: Apple Inc., Cupertino, CA (US)

(72) Inventors: Matthew L. STERN, Hermosa Beach, CA (US); Omar R. KHAN, San Ramon, CA (US); Karen N. WONG, Sunnyvale, CA (US)

(21) Appl. No.: 19/295,372

(22) Filed: Aug. 8, 2025

Related U.S. Application Data
(60) Provisional application No. 63/700,656, filed on Sep. 28, 2024.
(60) Provisional application No. 63/752,492, filed on Jan. 31, 2025.

(51) Int. Cl. G06T 19/00; G06V 10/25

(52) U.S. Cl. CPC G06T 19/006; G06V 10/25

(57) ABSTRACT

Methods and apparatuses for providing a view and/or virtual representation of an object. In some examples, a first electronic device is in communication with one or more input devices and a second electronic device. In some examples, the first electronic device identifies a region within a three-dimensional environment; captures, via the one or more input devices, a portion of the three-dimensional environment corresponding to the region identified within the three-dimensional environment; and transmits the portion of the three-dimensional environment corresponding to the region to the second electronic device.

### CROSS REFERENCE TO RELATED APPLICATIONS

This application claims the benefit of U.S. Provisional Application No. 63/752,492, filed Jan. 31, 2025, and U.S. Provisional Application No. 63/700,656, filed Sep. 28, 2024, the contents of which are herein incorporated by reference in their entireties for all purposes.

### FIELD OF THE DISCLOSURE

This relates generally to methods and apparatuses for providing a view and/or virtual representation of a real-world object.

### BACKGROUND OF THE DISCLOSURE

Some computer graphical environments provide two-dimensional and/or three-dimensional environments where at least some real-world objects displayed for a user's viewing are virtual and generated by a computer.

### SUMMARY OF THE DISCLOSURE

This relates generally to methods and apparatuses for providing a view and/or virtual representation of a real-world object (also referred to herein as an object more generally). In some examples, a first electronic device is in communication with one or more input devices and a second electronic device. In some examples, the first electronic device identifies a region within a three-dimensional environment; captures, via the one or more input devices, a portion of the three-dimensional environment corresponding to the region identified within the three-dimensional environment; and transmits the portion of the three-dimensional environment corresponding to the region to the second electronic device.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIG. 3 illustrates an example process for generating a view of an object according to some examples of the disclosure.

FIGS. 4A-4L illustrate examples of presenting a view and/or virtual representation of a real-world object according to some examples of the disclosure.

FIG. 5 illustrates a flow diagram illustrating an example process for transmitting a portion of a three-dimensional environment to an electronic device according to some examples of the disclosure.

FIG. 6 illustrates a flow diagram illustrating an example process for presenting a virtual representation of a real-world object according to some examples of the disclosure.

### DETAILED DESCRIPTION

Some examples of the disclosure are directed to methods and apparatuses for providing a view and/or virtual representation of a real-world object (also referred to herein as an object more generally). In some examples, a first electronic device is in communication with one or more input devices and a second electronic device. In some examples, the first electronic device identifies a region within a three-dimensional environment; captures, via the one or more input devices, a portion of the three-dimensional environment corresponding to the region identified within the three-dimensional environment; and transmits the portion of the three-dimensional environment corresponding to the region to the second electronic device. In some examples, while presenting a user interface element including a portion of a three-dimensional environment corresponding to the three-dimensional environment of the second electronic device, the first electronic device determines a physical object within the portion of the three-dimensional environment of the second electronic device and presents, within a three-dimensional environment of the first electronic device, a three-dimensional model corresponding to the physical object. Presenting a portion of the three-dimensional environment of the first electronic device to the second electronic device and presenting a portion of the three-dimensional environment of the second electronic device to the first electronic device can be particularly useful for collaboration and provides enhanced real-time guidance by presenting a same portion of the three-dimensional environment simultaneously to users located in different physical locations.

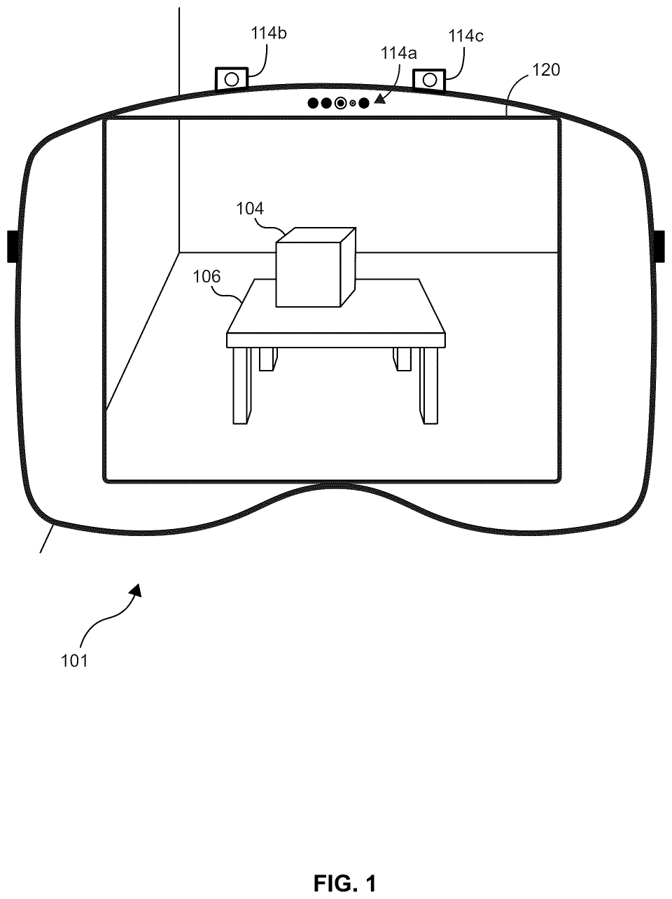

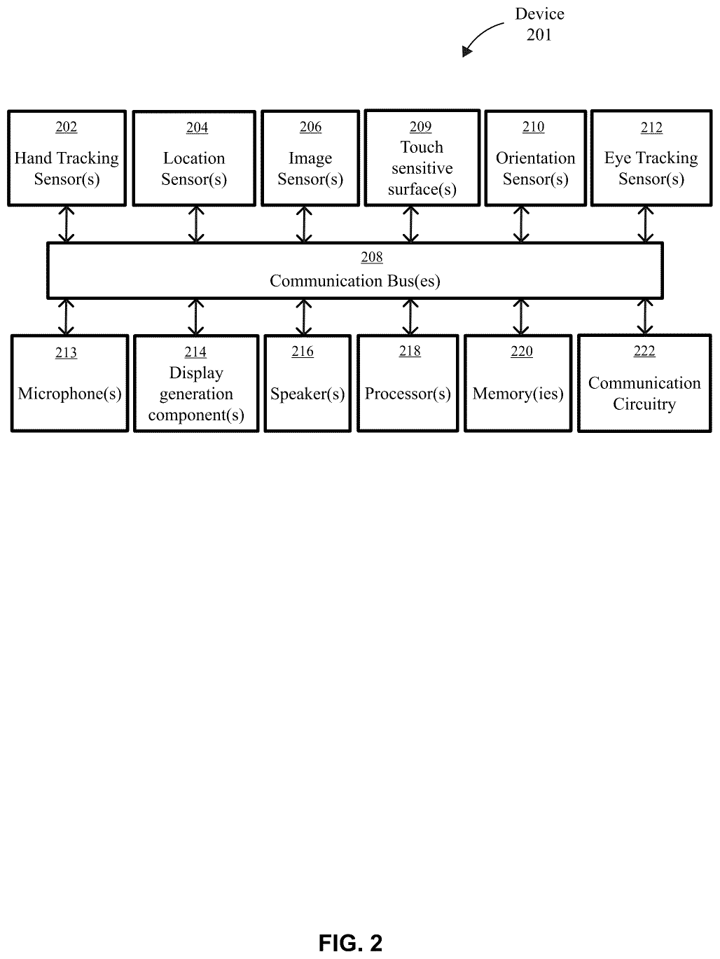

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment.

In some examples, the display 120 is provided as a passive component (e.g., rather than an active component) within electronic device 101. For example, the display 120 may be a transparent or translucent display, as mentioned above, and may not be configured to display virtual content (e.g., images of the physical environment captured by external image sensors 114b and 114c and/or virtual object 104). Alternatively, in some examples, the electronic device 101 does not include the display 120. In some such examples in which the display 120 is provided as a passive component or is not included in the electronic device 101, the electronic device 101 may still include sensors (e.g., internal image sensor 114a and/or external image sensors 114b and 114c) and/or other input devices, such as one or more of the components described below with reference to FIG. 2.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for an electronic device 201 according to some examples of the disclosure. In some examples, electronic device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

As described herein, electronic device 101 (e.g., the first electronic device) optionally transmits to a second electronic device a request for knowledge and/or guidance related to the configuration and/or maintenance of a physical object (or optionally, virtual object), such as a machine, computing system, consumer electronic device, software program, and/or the like. In some examples, the request is transmitted from a first user of the electronic device 101 to a second user of a second electronic device. In some examples, the first user of the electronic device 101 and the second user of the second electronic device are participants in a real-time or nearly real-time communication session (e.g., telephone or video conference) involving the transmission of captured video and/or audio content from one or more respective one or more input devices and/or one or more respective cameras from the electronic device 101 and/or the second electronic device.

In some examples, the communication session includes displaying and/or otherwise communicating, via the electronic device 101 and/or the second electronic device, an issue related to the physical object. In some examples, the second user of the second electronic device is troubleshooting and/or providing instructions to the first user of the first electronic device.

In some examples, while in communication with second electronic device, the electronic device 101 transmits a portion of a three-dimensional environment of the electronic device 101 that includes the physical object to the second electronic device as will be described in more detail below. In some examples, transmitting the portion of the three-dimensional environment of the electronic device 101 does not include transmitting an entire view of the three-dimensional environment of the electronic device 101. In some examples, the computer system does not transmit the entire view of the three-dimensional environment of the electronic device 101 because the user of the electronic device 101 elects not share the entire view and/or elects to share only the portion of the three-dimensional environment of the electronic device 101 (e.g., portions other than the portion that is transmitted are private to the first electronic device 101). In some examples, transmitting the portion of the three-dimensional environment includes initiating a process to cause the second electronic device to display a view of the portion of the three-dimensional environment of the electronic device 101 that includes the physical object. In some examples, the second electronic device presents the view overlaid on a portion of the three-dimensional environment of the second electronic device (e.g., the physical environment of the second electronic device) as will be described in more detail below.

In some examples, while and/or in response to presenting the view, the second electronic device presents a representation of the physical object (e.g., a virtual three-dimensional model corresponding to the physical object) within the three-dimensional environment of the second electronic device as will be described in more detail below. In some examples, the view and/or representation of the physical object is presented to the second user of the second electronic device, such that the second user is enabled to view and interact with the representation of the physical object in their three-dimensional environment (e.g., similar to as if the object is in the physical environment of the second user of the second electronic device).

Additionally or alternatively, electronic device 101 provides a stabilized view of the physical object to the second user of the second electronic device. In some examples, the stabilized view may show the physical object substantially stationary, thus cancelling the effect of any movement that can cause unsteady images in the video. For example, the user of the electronic device 101 can be moving as they are engaged in communication with the second user of the second electronic device, and the stabilized view that is presented to the second user of the second electronic device may show the physical object staying substantially stationary. Thus, in some examples, providing a stabilized view of the physical object improves image quality in a video captured and transmitted to the second electronic device. Additionally or alternatively, the electronic device 101 and/or the second electronic device presents annotations and/or indications of annotations to the physical object that are presented within the view of the physical object, the representation of the physical object, and/or overlaid on the physical object itself as will be described in more detail below.

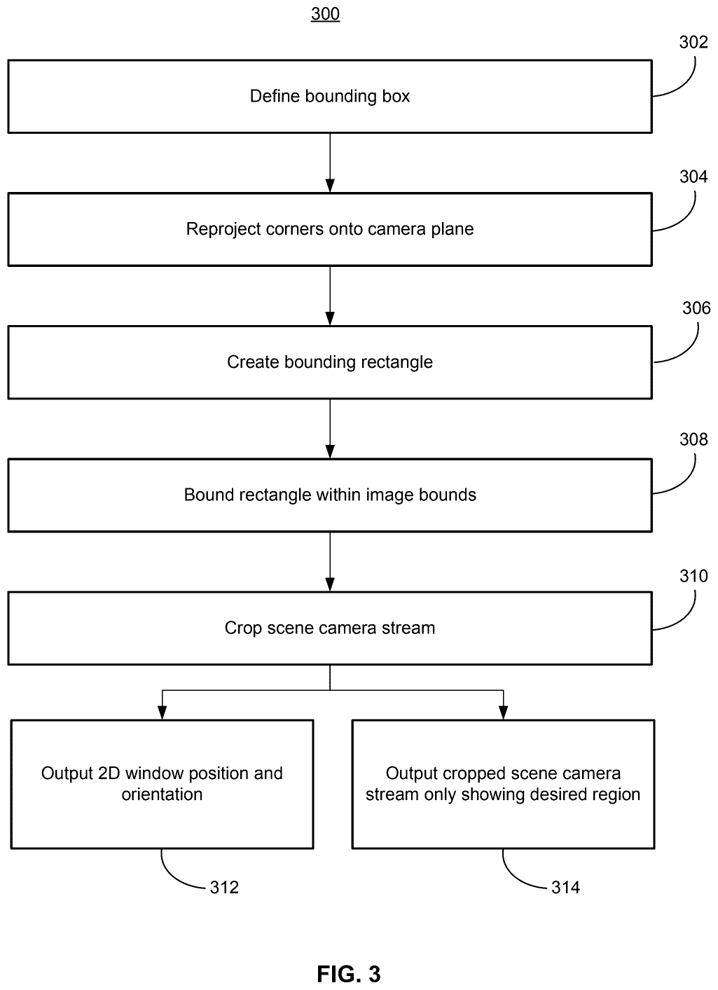

FIG. 3 illustrates an example process for generating a view of an object according to some examples of the disclosure. In some examples, the electronic device 101 (e.g., first electronic device) described above with reference to FIGS. 1 and 2 can perform method 300. For example, method 300 includes the electronic device 101 defining a bounding box (302) or two-dimensional container, or three-dimensional volume. In some examples, the bounding box optionally serves as a container for a region within the three-dimensional environment of the electronic device 101. For the purposes of sharing a representation of a physical object, the region includes the physical object (e.g., real-world object in the physical environment of the electronic device 101). In some examples, the electronic device 101 transmits a portion of the three-dimensional environment of the electronic device 101 corresponding to the region (e.g., based on the bounding box) to the second electronic device. In some examples, and as described in method 300, the electronic device 101 initiates a process to cause the second electronic device to display the portion within a three-dimensional environment of the second electronic device. In some examples, the electronic device 101 shares the portion during a communication session with the second electronic device.

In some examples, defining the bounding box includes presenting, via one or more displays (e.g., display 120 of FIG. 1), a representation of a two-dimensional bounding area or a three-dimensional bounding volume to capture a target region including a target physical object. In some examples, the representation of the two-dimensional bounding area includes a user interface window element specifying a boundary around the region of the three-dimensional environment of the electronic device 101 (e.g., in x and y coordinates). In some examples, the representation of the three-dimensional bounding volume includes a user interface volume element specifying the boundary around the region in the three-dimensional environment of electronic device 101 (e.g., in x, y, and z coordinates). In some examples, the electronic device 101 identifies the region within the three-dimensional environment based on one or more dimensions of a three-dimensional bounding region as defined by the two-dimensional bounding area or a three-dimensional bounding volume (e.g., bounding box or volume). In some examples, the electronic device 101, displays, via the one or more displays, the bounding box with a first area or volume and at a first location within the three-dimensional environment. In some examples, the electronic device 101 detects user input, via the one or more input devices, directed to the bounding box to move and/or change a size of the bounding box or volume in one or more dimensions. For example, the user input corresponds to moving bounding box (e.g., the representation of the two-dimensional bounding area or the three-dimensional bounding volume) within the three-dimensional environment from a first location to a second location within the three-dimensional environment. In some examples, the second location includes a second portion of the physical object, different from a first portion of the physical object associated with the first location of the bounding box. In some examples, the user input corresponds to a request to increase or decrease a size or volume of the bounding box, rotating the bounding box, or other suitable transformations of the bounding box. In some examples, the user input is an attention-based gesture input or voice input, or any of the other inputs described herein.

In some examples, the electronic device 101 automatically displays the bounding box to include/capture the physical object without requiring detecting user input directed to the bounding box to include the target region including the physical object. For example, the electronic device 101 detects, using object detection and tracking (ODT) or other object recognition methodologies, the physical object. In some examples, detecting the physical object includes automatically moving and/or resizing the bounding box to include the detected physical object (e.g., without detecting explicit user input to move and/or resize the bounding box). In some examples, the electronic device 101 requests user confirmation that the detected object is the target object. For example, the electronic device 101 detects user input confirming that the bounding box automatically defined by the electronic device that includes the detected object is the target object to be shared with the second electronic device.

In some examples, after (and/or while) defining the bounding box, the electronic device 101 reprojects corners (e.g., of the bounding box) onto a camera plane (304). For example, the electronic device 101 transforms the two-dimensional coordinates (or optionally, the three-dimensional coordinates) of the bounding box onto the camera plane (e.g., defined by the one or more image sensors 206) of the electronic device 101. In some examples, and as described above with reference to FIG. 2, the one or more image sensors 206 are configured to face outwards from the first user so as to obtain information corresponding to the scene (e.g., three-dimensional environment including the physical environment) of the electronic device 101. In some examples, the electronic device 101 derives a distance between the one or more image sensors 206 and the physical object based on the dimensions of the bounding box and/or intrinsic and/or extrinsic image sensor parameters. In some examples, the intrinsic parameters of the one or more image sensors include field to view/focal length, sensor size, sensor height, and/or other intrinsic sensor parameter. In some examples, the extrinsic image sensor parameters include position and/or orientation of the one or more image sensors 206 relative to the three-dimensional environment.

In some examples, the electronic device creates a bounding rectangle (306) or box or volume, or any other shape. For example, the electronic device 101 captures a portion of the three-dimensional environment corresponding to the target region including the target physical object identified via the bounding box as described above. In some examples, the bounding rectangle is two-dimensional or three-dimensional. In some examples, the electronic device 101 sets one or more desired parameters of the bounding rectangle, such as one or more margins, alignment, and/or other desired parameters. In some examples, capturing the portion of the three-dimensional environment corresponding to the target region includes generating a two-dimensional bounding area that is based on a current viewpoint of the first user of the electronic device 101. In some examples, the electronic device 101 bounds the rectangle within image bounds (308) to ensure a stable visual output. For example, the electronic device 101 clamps the bounding rectangle to one or more edges of the image bounds. Clamping the bounding rectangle to the one or more edges of the image bounds includes restricting the bounding rectangle to within the image bounds so as to not extend beyond the image bounds which, in turn, reduces unnecessary computation related to out-of-bound portions.

In some examples, the electronic device 101 crops the scene camera stream (310) (e.g., one or more image sensors 206 stream(s)). For example, capturing the portion of the three-dimensional environment corresponding to the target region includes cropping a portion of the camera stream captured by the one or more input devices (e.g., the one or more image sensors 206) that is framed within the two-dimensional bounding area (e.g., bounding rectangle described above). In some examples, the electronic device 101 generates at least two outputs (312): two-dimensional window position and orientation information; and a cropped scene camera stream that only shows the desired region (314). In some examples, the two dimensional window position and orientation information is based on the bounding rectangle described above. In some examples, the two dimensional window position and orientation information is used to generate an enhanced cropped camera scene as described in more detail below. In some examples, outputs, such as 312 and/or 314 are transmitted to a second electronic device. In some examples, and as described in more detail below transmitting outputs 312 and/or 314 includes initiating a process to cause the second electronic device to display a view of the enhanced camera scene including the physical object and/or a view of the target region including the physical object. In some examples, transmitting outputs 312 and/or 314 includes initiating a process to cause the second electronic device to display a virtual representation of the physical object. This example process of providing a stabilized and/or enhanced view of the physical object and/or a region of the respective three-dimensional environment (e.g., of the first electronic device) provides an efficient way of presenting live video (e.g., to the second electronic device) that is consistent and without motion artifacts (or a reduced amount of motion artifacts), which provides a smooth and seamless viewing experience for the user, enhances operability of the electronic device, reduces power usage of the electronic device, optimizes bandwidth, reduces video transmission errors, reduces errors in the interaction between the user and the electronic device, and reduces inputs needed to correct such errors.

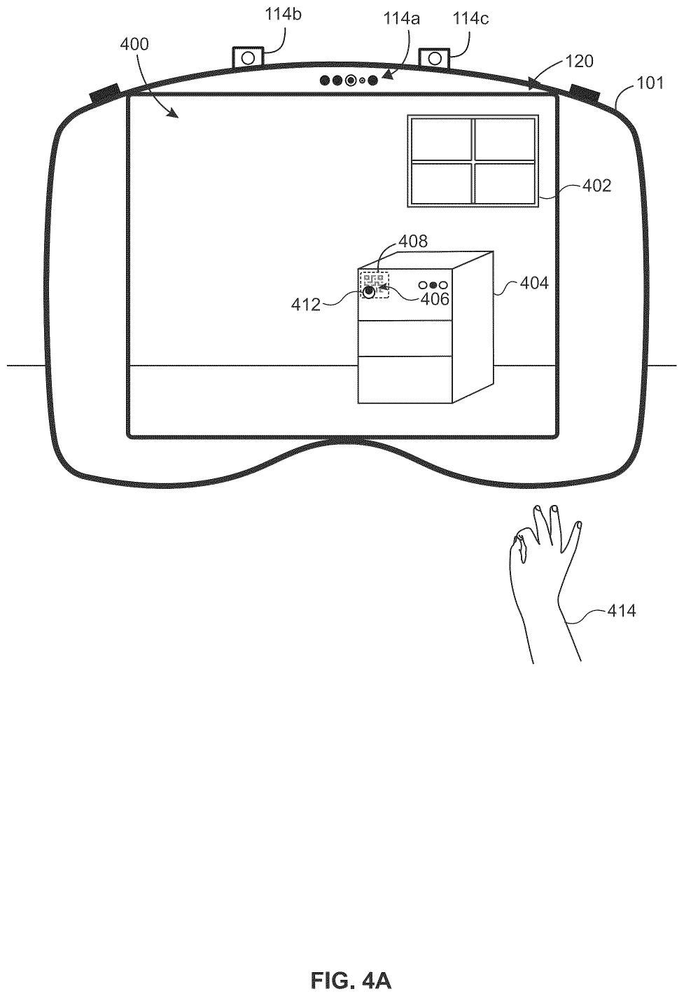

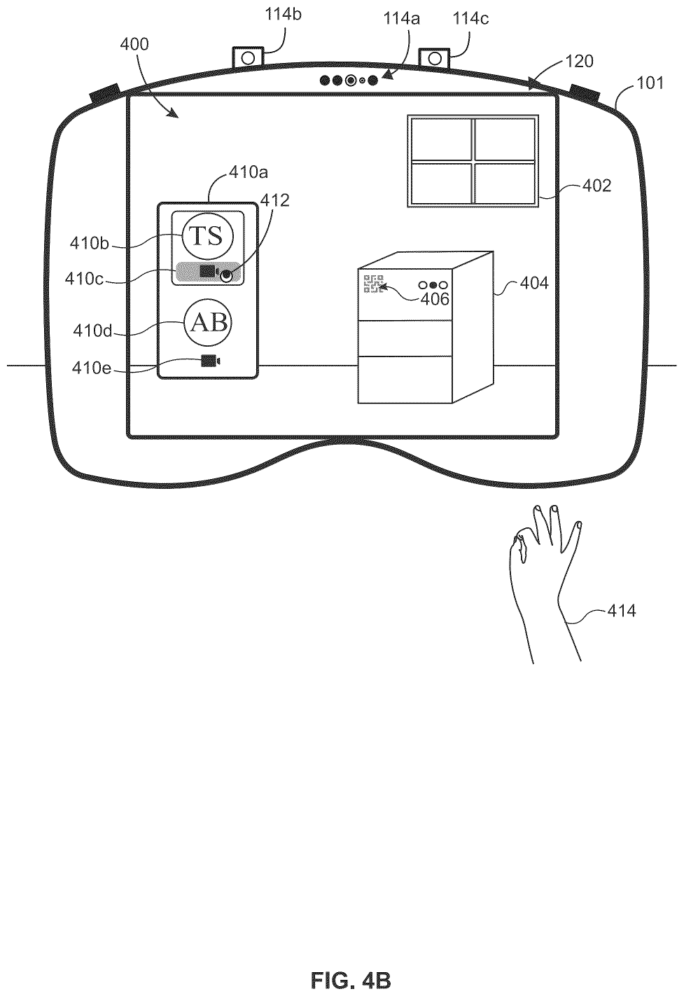

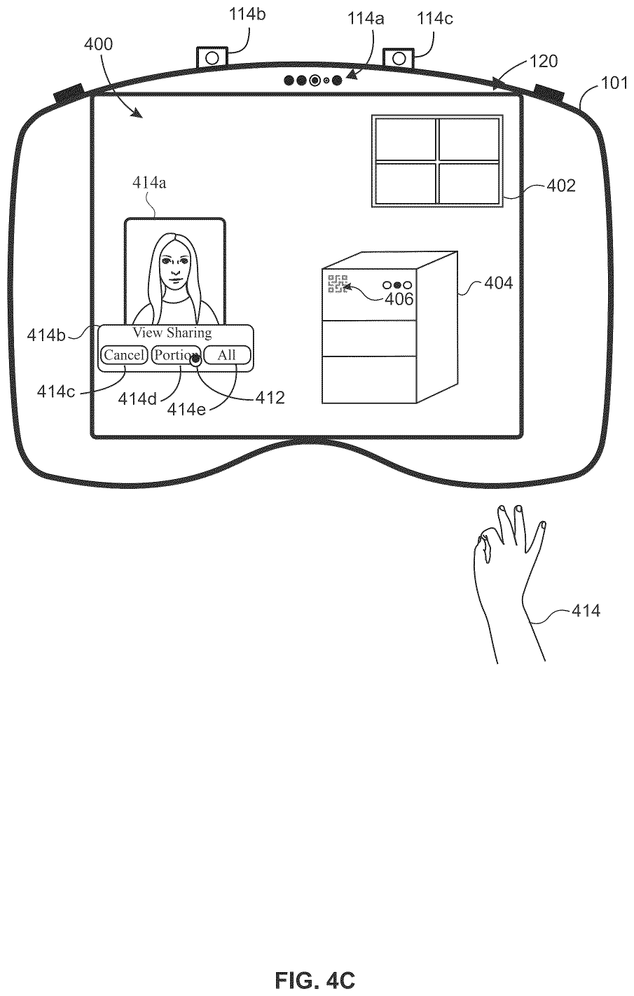

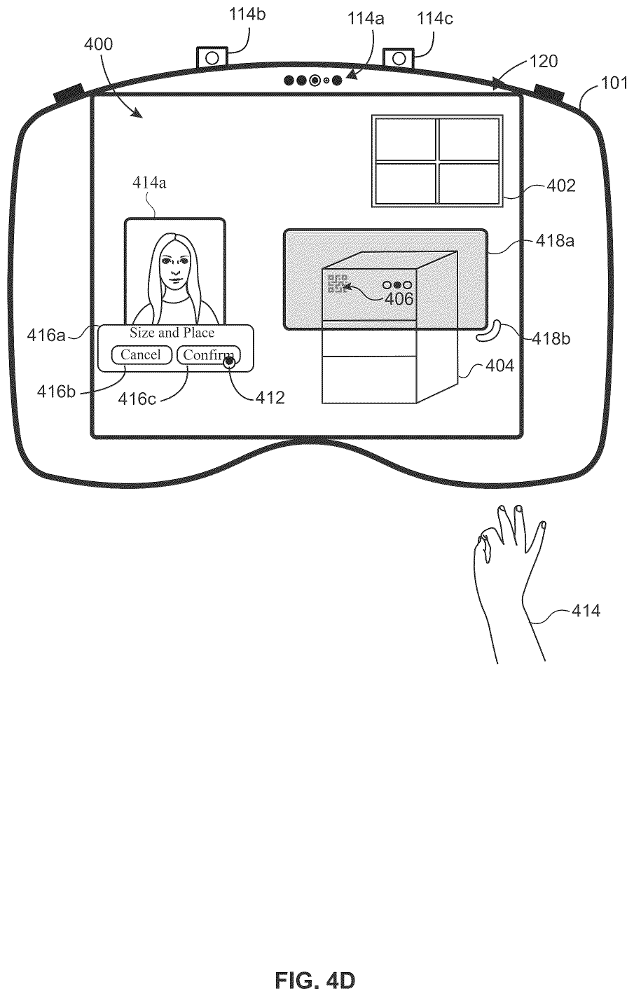

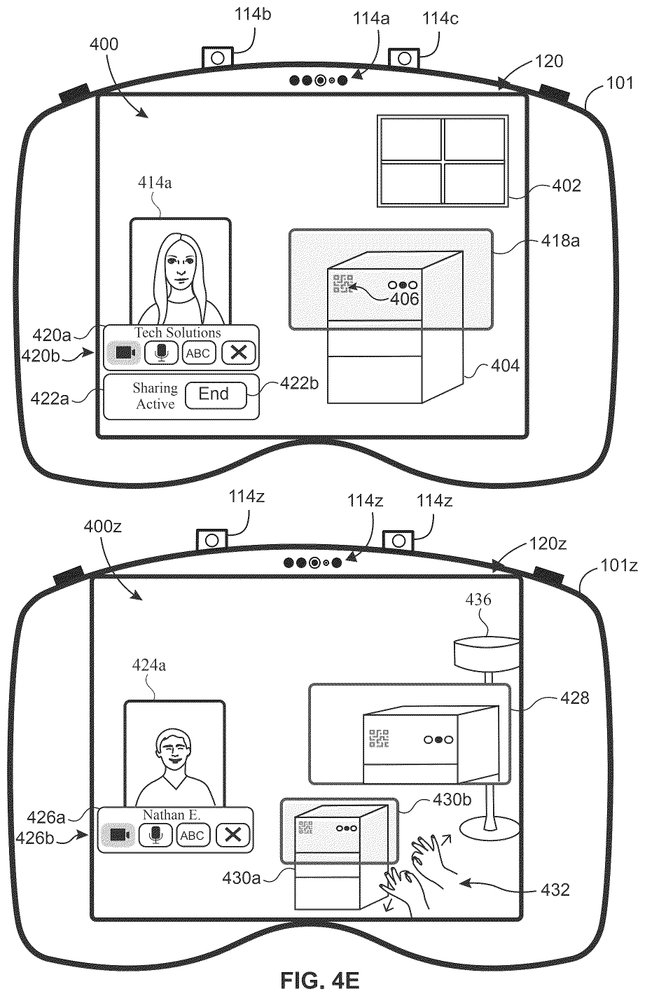

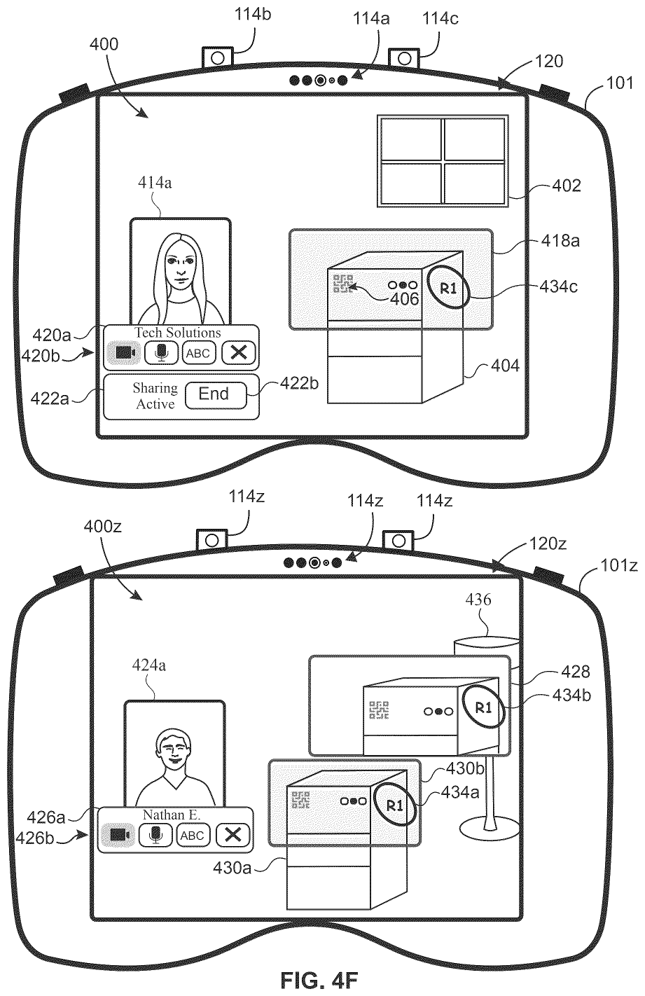

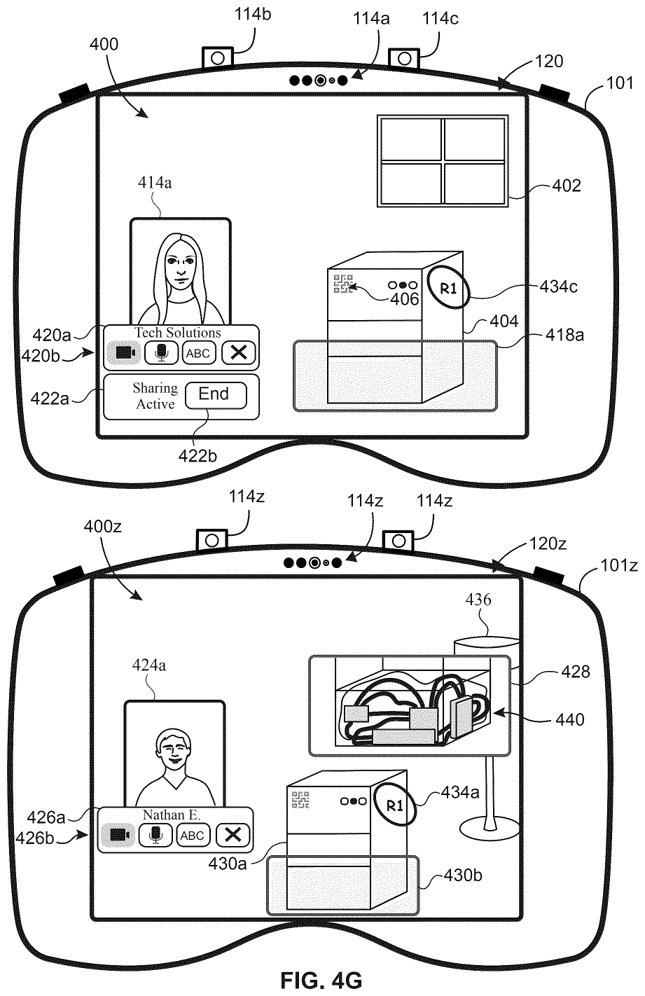

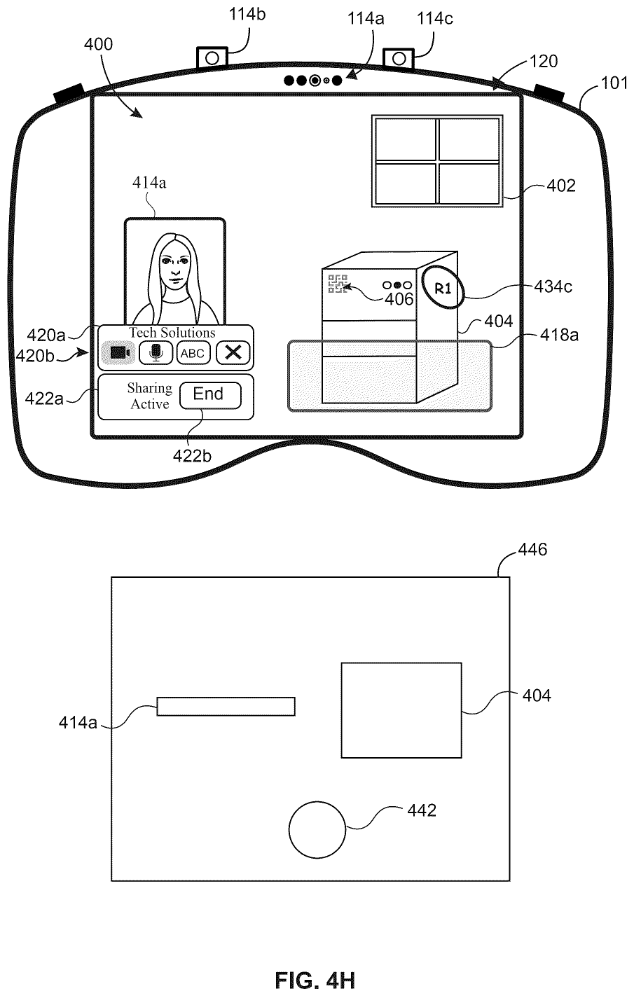

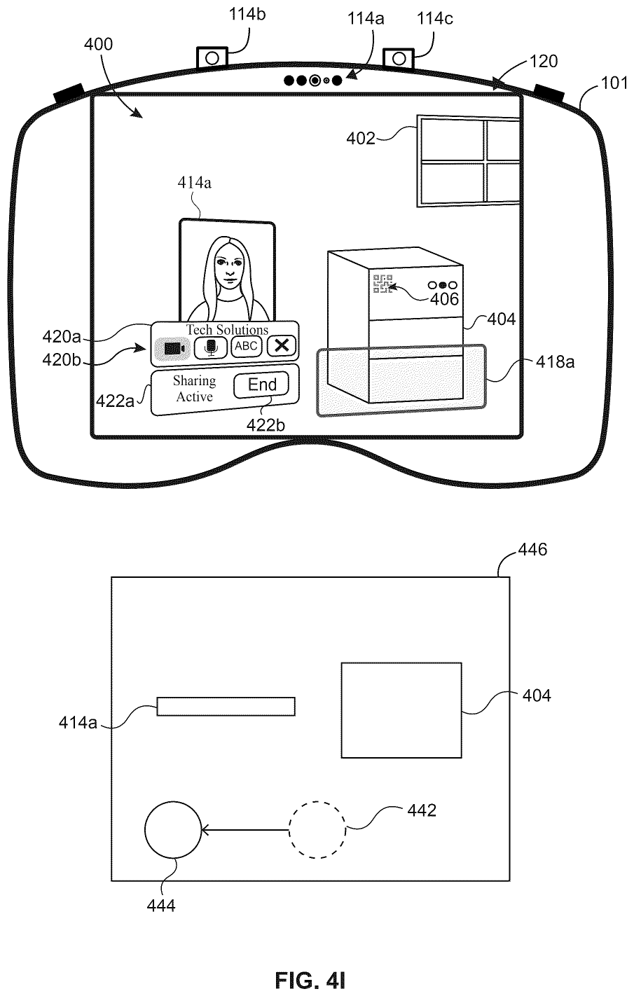

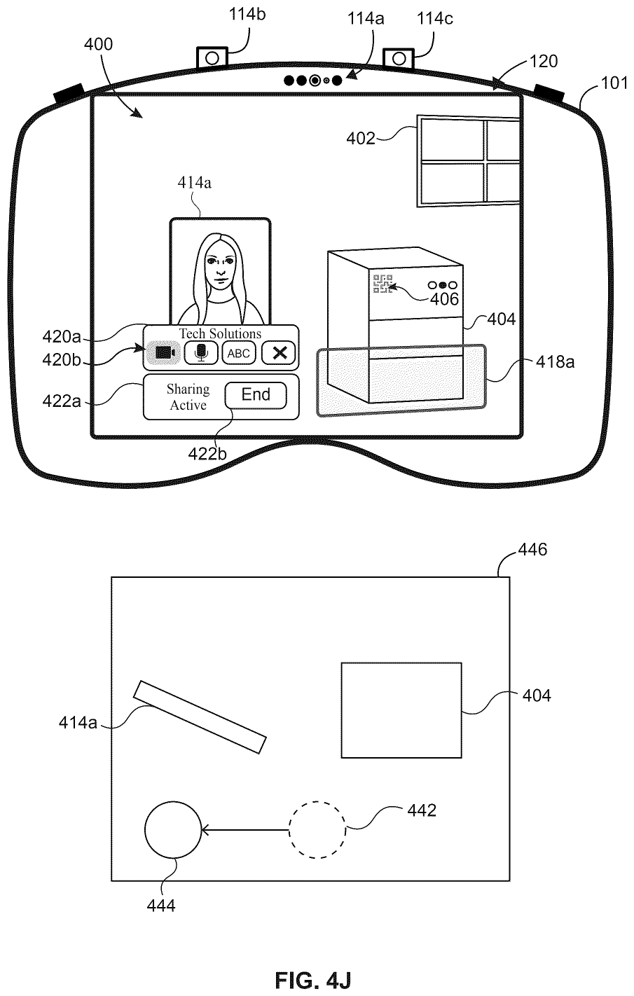

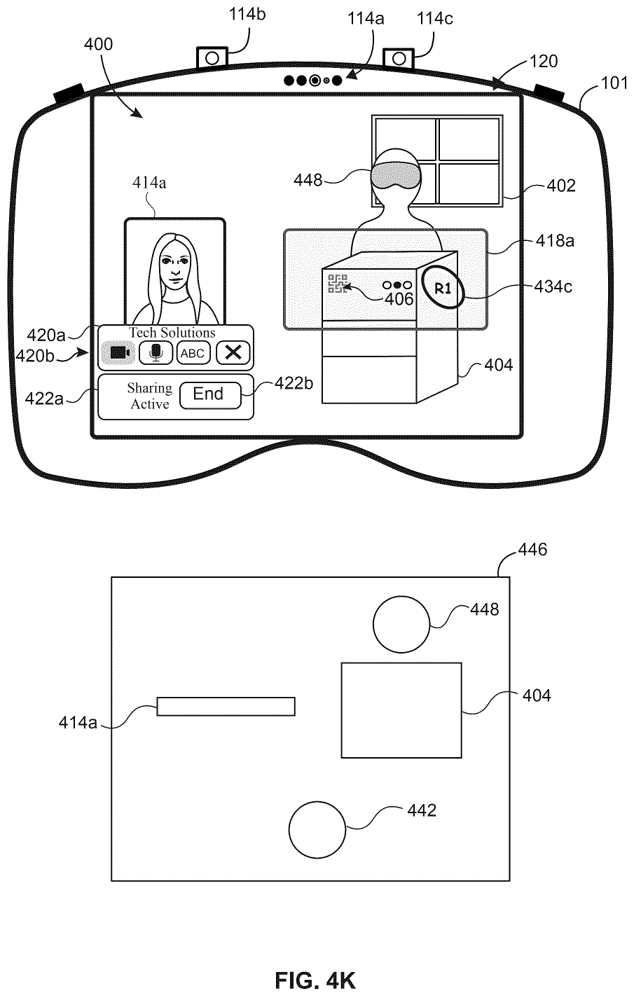

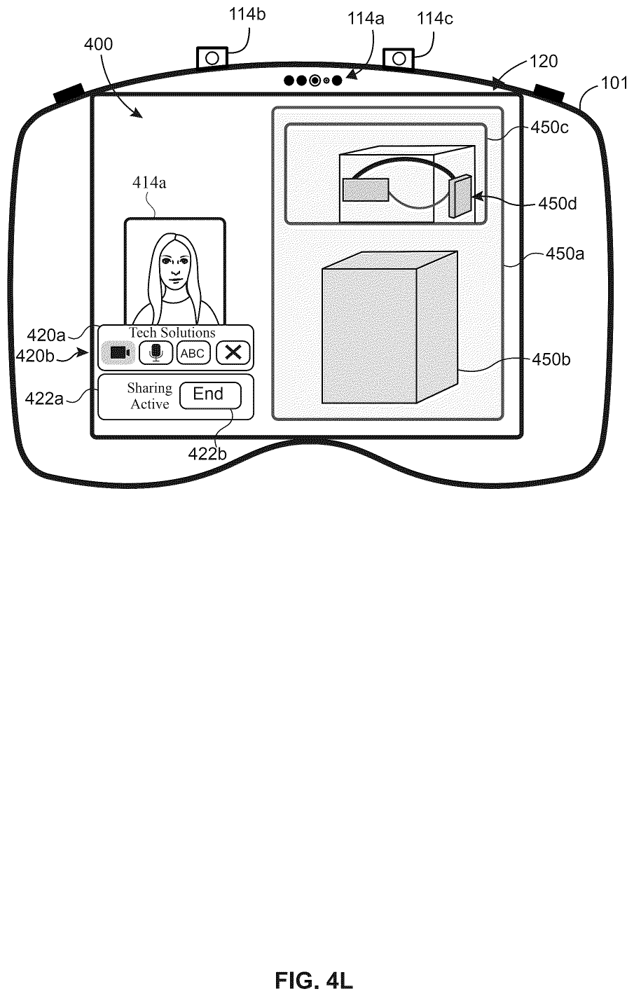

FIGS. 4A-4L illustrate examples of presenting a view and/or virtual representation of a real-world object according to some examples of the disclosure. FIG. 4A illustrates electronic device 101 or optionally, referred to the first electronic device 101 (e.g., electronic device 101 of FIG. 1; and electronic device 201 of FIG. 2) presenting a computer-generated environment 400 or optionally referred to as a three-dimensional environment 400 (e.g., an extended reality (XR) environment, a three-dimensional environment, etc.) according to some examples of the disclosure. The computer-generated environment 400 (or optionally, referred to as the three-dimensional environment) is visible from a viewpoint of a first user of the first electronic device 101 (e.g., facing a back wall and in-between two walls of the physical environment in which the first electronic device 101 is located). In some examples, the first electronic device 101 is a hand-held or mobile device, such as a tablet computer, laptop computer, smartphone, a wearable device, or head-mounted display. Examples of the first electronic device 101 are described above with reference to the architecture block diagram of FIG. 2. As shown in FIG. 4A, the first electronic device 101, window 402, and machine 404 are located in the physical environment of the computer-generated environment 400. In some examples, the first electronic device 101 may be configured to capture areas of the physical environment including window 402 and the machine 404 (e.g., physical object).

In some examples, the viewpoint of the first user of the first electronic device 101 determines what content is visible in a viewport (e.g., a view of the three-dimensional environment visible to the user via one or more displays, such as the one or more image sensors 206, or a pair of display modules that provide stereoscopic content to different eyes of the same user). In some examples, the (virtual) viewport has a viewport boundary that defines an extent of the three-dimensional environment that is visible to the first user via the one or more displays (e.g., display 120 in FIGS. 4A-4L). In some examples, the region defined by the viewport boundary is smaller than a range of vision of the first user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the first user in one or more dimensions (e.g., based on the range of vision of the user, size, optical properties or other physical characteristics of the one or more displays, and/or the location and/or orientation of the one or more displays relative to the eyes of the first user). The viewport and viewport boundary typically move as the one or more displays move (e.g., moving with a head of the first user for a head-mounted device or moving with a hand of the first user for a handheld device such as a tablet or smartphone). A viewpoint of the first user determines what content is visible in the viewport, a viewpoint generally specifies a location and a direction relative to the three-dimensional environment, and as the viewpoint shifts, the view of the three-dimensional environment will also shift in the viewport. For a head-mounted device, a viewpoint is typically based on a location, a direction of the head, face, and/or eyes of the first user to provide a view of the three-dimensional environment that is perceptually accurate and provides an immersive experience when the first user is using the head-mounted device. For a handheld or stationed device, the viewpoint shifts as the handheld or stationed device is moved and/or as a position of the first user relative to the handheld or stationed device changes (e.g., a user moving toward, away from, up, down, to the right, and/or to the left of the device). For devices that include one or more displays with video-passthrough (or, optionally, referred to as virtual-passthrough), portions of the physical environment that are visible (e.g., displayed, and/or projected) via the one or more displays are based on a field of view of one or more cameras in communication with the one or more displays which typically move with the one or more displays (e.g., moving with a head of the first user for a head-mounted device or moving with a hand of the first user for a handheld device such as a tablet or smartphone) because the viewpoint of the first user moves as the field of view of the one or more cameras moves (and the appearance of one or more virtual objects displayed via the one or more displays is updated based on the viewpoint of the first user (e.g., displayed positions and poses of the virtual objects are updated based on the movement of the viewpoint of the first user)). For the one or more displays with optical-passthrough, portions of the physical environment that are visible (e.g., optically visible through one or more partially or fully transparent portions of the display generation component) via the one or more display generation components are based on a field of view of the first user through the partially or fully transparent portion(s) of the display generation component (e.g., moving with a head of the first user for a head-mounted device or moving with a hand of the first user for a handheld device such as a tablet or smartphone) because the viewpoint of the first user moves as the field of view of the user through the partially or fully transparent portions of the display generation components moves (and the appearance of one or more virtual objects is updated based on the viewpoint of the first user).

FIGS. 4A-4L illustrate an example use case where the first user of the first electronic device 101 initiates a communication session with a customer service representative for customer support related to machine 404 (e.g., referred to as the object or physical object). In some examples, the first electronic device 101 captures the machine for view in a communication session with the customer service representative, optionally upon the first user initiating the communication session. In some examples, the first electronic device 101 identifies the machine 404, and transmits the identity of the machine 404 to the customer service representative. For example, in FIG. 4A, the machine 404 includes machine readable code 406 (e.g., a bar code, quick-response (QR) code, displayed characters, or another type of visual pattern that includes machine readable information). In some examples, the first electronic device 101 detects user input (e.g., an air pinch gesture 414 while attention 412 (e.g., gaze) of the first user of the first electronic device 101 is directed to a location corresponding to the machine readable code 406 of the machine 404. In some examples, the first electronic device 101 infers that the attention 412 of the first user directed to the machine readable code 406 is indicative of the first user intending to activate the QR code (e.g., initiate a process related to the QR code). In some examples, while and/or in response to detecting that the attention 412 of the first user is directed to machine readable code 406, and optionally, prior to detecting the air pinch gesture 414, the electronic device 101 presents, via display 120, an indication 408 that the attention 412 of the user is focused on the machine readable code 406. In FIG. 4A, the indication 408 includes a dotted line container or box that surrounds the machine readable code 406. In some examples, displaying the indication 408 provides an indication that the attention of the user is directed to the machine readable code 406. In some examples, displaying the indication 408 notifies the first user that the machine readable code 406 is selectable to perform an action associated with the machine 404 (e.g., display information about the machine 404, initiate a communication session with a customer service representative as described in more detail below, and/or any of the other actions described below).

Additionally or alternatively, the first electronic device 101, using optical character recognition (OCR), ODT methodology (e.g., described above), computer vision, and/or other scanning technology, identifies the machine 404 and presents machine readable code 406. For example, the first electronic device 101 captures one or more images of machine 404 using the one or more input devices and determines the identity of the machine 404 using the one or more images to retrieve and present machine readable code 406. Thus, in some examples, the machine readable code 406 was not provided by the machine 404 (e.g., not included in the physical environment of the first electronic device 101) prior to detecting that the attention of the user is directed to the machine 404. In some examples, the first electronic device 101 transmits information associated with the machine readable code 406 for look-up in a remote server/database and/or local database (e.g., maintained by first electronic device 101 from an application operating on the first electronic device 101 and/or by a third-party in communication with the first electronic device 101 to retrieve customer service information for the machine 404. In some examples, the first electronic device 101 retrieves other information (e.g., content, graphics, and/or metadata) about the machine 404.

In some examples, in response to detecting the air pinch gesture 414 while the attention 412 of the first user is directed to the machine readable code 406, as shown in FIG. 4A, the first electronic device 101 displays, via display 120, a user interface element 410a, as shown in FIG. 4B. Additionally or alternatively, the electronic device 101 displays user interface element 410a without detecting user input including air pinch gesture 414 and attention 412. For example, the first electronic device 101 captures one or more images of machine 404 using the one or more input devices (e.g., the one or more image sensors 206) and determines the identity of the machine 404 using the one or more images to retrieve customer service information. In FIG. 4B, user interface element 410a includes a representation of a first customer service representative 410b associated with the machine 404 (e.g., as identified via machine readable code 406) and an option 410c to start a communication session (e.g., audio and/or video communication session) with the first customer service representative. User interface element 410a also includes a representation of a second customer service representative 410d associated with the machine 404 and an option 410e to start a communication session with the second customer service representative. In FIG. 4B, the first electronic device 101 detects user input (e.g., an air pinch gesture 414) while attention 412 (e.g., gaze) of the first user of the first electronic device 101 is directed to the option 410c. In some examples, in response to detecting the user input including air pinch gesture 414 and attention 412 in FIG. 4B, the first electronic device 101 initiates a communication session with the first customer service representative or as referred to herein as the second user of the second electronic device.

In some examples, initiating a communication session with the second user of the second electronic device includes sharing a stabilized view (e.g., substantially stationary view) of a portion of the three-dimensional environment (e.g., as described in more detail with reference to FIG. 3). For example, and as shown in FIG. 4C, upon initiating the session with second user of the second electronic device, the electronic device 101 displays a representation of the second user 414a (or, optionally, a representation of the first customer service presentative, such as an avatar or three-dimensional persona). In some examples, the first electronic device 101 displays user interface element 414b that includes a first option 414c that, when selected causes the first electronic device to cancel sharing a view of the three-dimensional environment 400 of the first electronic device 101. In some examples, user interface element 414b includes a second option 414d that, when selected, causes the first electronic device 101 to initiate sharing a portion of the machine 404; and a third option 414e that, when selected, causes the first electronic device 101 to display the entire machine 404 (or, optionally, a view of the three-dimensional environment 400 of the first electronic device 101 from the viewpoint of the first user of the first electronic device 101).

In some examples, and a shown in FIG. 4C, the first electronic device 101 detects user input (e.g., an air pinch gesture 414 while attention 412 (e.g., gaze) of the user of the first electronic device 101) directed to a location corresponding to the second option 414d indicative of sharing a portion of the machine 404 (or, optionally, a portion of the three-dimensional environment 400 of the first electronic device 101). In some examples, in response to detecting the user input in FIG. 4C, the first electronic device 101 displays as shown in FIG. 4D, via the display 120, user interface elements 418a and control user interface element 418b that are interactable to select and/or define a portion of the three-dimensional environment 400 of the first electronic device 101 to share to the second electronic device of the second user. For example, the electronic device 101 can increase or decrease a size or volume of a bounding region as indicated by user interface element 418a using control user interface element 418b. In some examples, the first electronic device 101 detects user input (e.g., an air pinch gesture 414 including movement while attention 412 (e.g., gaze) of the first user directed to the control user interface element 418), and in response, the first electronic device 101 resizes the control user interface element 418b (e.g., the bounding region) in accordance with the movement of the air pinch gesture 414.

In some examples, and a shown in FIG. 4D, the first electronic device 101, displays, via the display 120, user interface element 416a that includes a first option 416b that, when selected, causes the first electronic device 101 to cancel sharing a view of the three-dimensional environment 400 of the first electronic device 101; and a second option 416c that, when selected, causes the first electronic device 101 to confirm that the portion as indicated by user interface element 418a is the portion of the three-dimensional environment 400 that is to be shared to the second electronic device. For example, in FIG. 4D, the first electronic device 101 detects user input (e.g., an air pinch gesture 414 while attention 412 (e.g., gaze) of the first user of the first electronic device 101 is directed to a location corresponding to the second option 416c), and in response, the first electronic device 101 shares the selected portion of the three-dimensional environment 400 to the second electronic device 101z (e.g., the electronic device of the first customer service representative), as shown in FIG. 4E. In some examples, the first electronic device 101 applies a visual treatment (e.g., blurring effect or other effect described herein) to a second portion of a camera stream captured by the one or more input devices (e.g., portions other than the portion of the three-dimensional environment corresponding to the region as described herein). In some examples, the first electronic device 101 applies the visual treatment in this manner to focus on the region and/or prevent unintentional display of the second portion. In some examples, the computer system applies the visual treatment in the manner described herein because the user of the first electronic device 101 elects not to share the entire view and/or elects to share only the region of the three-dimensional environment of the first electronic device 101 (e.g., regions other than the region that is selected are private to the first electronic device 101 and are not shared or viewable by the second electronic device). In some examples, the first electronic device 101 applies the visual treatment to the second portion, outside the portion of the three-dimensional environment corresponding to the region, prior to transmitting the portion of the region to the second electronic device. In some examples, after applying the visual treatment to the second portion, the first electronic device 101 transmits the second portion of the three-dimensional environment to the second electronic device.

FIG. 4E illustrates the three-dimensional environment 400z of the second user of the second electronic device 101z (e.g., the first customer service representative). As shown in FIG. 4E, environment 400z of the second electronic device 101z includes physical objects, such as a lamp 436, though in some examples, the three-dimensional environment 400z can be an XR environment without physical objects. In FIG. 4E, the portion of the three-dimensional environment 400 of the first electronic device 101 (e.g., selected by the first user of the first electronic device 101 described above) is presented within the three-dimensional environment 400z of the second electronic device 101z via a window or user interface element 428. In some examples, the first electronic device 101 enhances the portion of the three-dimensional environment corresponding to the region prior to transmitting the portion of the region to the second electronic device 101z. For example, the first electronic device 101 can change a level of brightness, increase a size of the content, increase a sharpness level, and/or apply other visual treatments to increase the readability of the content. In some examples, while the second electronic device 101z is in a communication session with the first electronic device 101, the second electronic device 101z displays, via the display 120z, the representation of the first user 424a of the first electronic device 101, such as an avatar, three-dimensional persona, or other representation of the first user of the first electronic device 101. In some examples, the second electronic device 101z displays user interface element 426a that includes the name or identifier of the first user and/or one or more options 426b that, when selected causes the second electronic device 101z to perform an operation associated with the communication session, such as enabling or disabling video during the communication session; enabling or disabling a microphone; ending the communication session; or other operation as described herein. In some examples, while the first electronic device 101 and the second electronic device 101z are in a communication session, the first electronic device 101 displays, via the display 120, the representation of the second user 414a of the second electronic device 101z (or optionally referred to a user interface element 414a) as described above. In some examples, the first electronic device 101 displays, via the display 120, user interface element 420a including one or more options 420b. In some examples, the user interface element 420a is analogous to and/or includes one or more characteristics of the user interface element 426a described above. In some examples, the one or more options 420b is analogous to and/or includes one or more characteristics of the one or more options 426b described above. In some examples, the first electronic device 101 displays, via the display 120, user interface element 422a indicating that the first electronic device 101 is sharing the portion of the three-dimensional environment 400 and an option 422b that, when selected, causes the first electronic device 101 to end or terminate the communication session.

In some examples, and as shown in FIG. 4E, the first electronic device 101 transmits a three-dimensional model corresponding to machine 404 in the three-dimensional environment 400 of the first electronic device 101 to the second electronic device 101z for concurrent presentation with the portion of the three-dimensional environment corresponding to the region via the second electronic device 101z, such as shown via user interface element 428. For example, in FIG. 4E, the second electronic device 101z displays, via the display 120z, a representation 430a (e.g., three-dimensional model) of the machine 404. In some examples, the second electronic device 101z displays the representation 430a receiving the three-dimensional model and/or an indication of the three-dimensional model from the first electronic device 101. For example, the second electronic device 101z determines the machine 404 within the user interface element 428 using one of the object recognition techniques described above and/or using the machine readable code 406 to retrieve a computer-aided design (CAD) model of the machine 404 to generate the representation 430a. In some examples, the second user (e.g., first customer service representative) of the second electronic device 101z can interact with the representation 430a. For example, the second electronic device 101z detects user input 432 (e.g., two-handed pinch gesture as described above) corresponding to a request to enlarge or zoom in on a particular area of the representation 430a, and in response, the second electronic device 101z enlarges the representation 430a, as shown in FIG. 4F, with a size larger than the respective size of the representation 430a prior to detecting user input 432, such as shown by representation 430a in FIG. 4E. In some examples, the second electronic device 101z displays a second user interface element 430b at a location of the representation 430a indicative of the portion of the machine 404 being presented by the first electronic device 101. In some examples, while displaying the representation 430a, the second electronic device 101z presents an indication of a location of the first user of the first electronic device 101 relative to the machine 404 (e.g., representation 430a).

In some examples, the first electronic device 101 and/or the second electronic device 101z presents one or more annotations made by the first electronic device 101 and/or the second electronic device 101z to the machine 404 and/or the representation 430a. For example, the first electronic device 101 receives from the second electronic device 101z an indication of an input received at the second electronic device 101z, such as, for example, an input corresponding to a request to add annotation 434a to the representation 430a, as shown in FIG. 4F. In some examples, the first electronic device 101 presents an annotation 434c in the three-dimensional environment 400 corresponding to the portion of the three-dimensional environment corresponding to the region, such as the region shown via the user interface element 418a or a physical object (e.g., machine 404) within the portion of the three-dimensional environment 400 corresponding to the region. In some examples, the annotation 434c corresponds to the input received at the second electronic device, such as, for example, an input to add the annotation 434a in FIG. 4F. In some examples, the annotation is presented in the portion of the three-dimensional environment corresponding to the region via the second electronic device 101z, such as shown by the annotation 434b in FIG. 4F.

In some examples, the first electronic device 101 and/or the second electronic device 101z presents supplemental information (e.g., internal wiring and/or circuitry content) associated with the machine 404. For example, in FIG. 4G, while presenting representation 430a, the second electronic device 101z detects user input (e.g., similar to user input 432 or user input 414 as described above) corresponding to a request to view the supplemental information associated with the machine 404. In some examples, the user input includes moving the second user interface element 430b to a capture a different portion of the representation 430a, as shown in FIG. 4G and a voice input requesting to present the supplemental information. In some examples, in response to detecting the user input, the second electronic device 101z presents user interface element 428 including a representation of the supplemental information 440. In some examples, the representation of the supplemental information 440 is presented overlaid the respective portion of the representation 430a. In some examples, while presenting the representation of the supplemental information, the first electronic device 101 automatically moves (e.g., without user input) the user interface element 418a to a location corresponding to the location of the second user interface element 430b. Thus, in some examples, the first user of the first electronic device 101 is aware of the particular portion of the machine 404 the second user of the second electronic device 101z is viewing.

In some examples, the first electronic device 101 initially (e.g., at the start of the communication session with the second user of the second electronic device 101z) presents respective orientations of the user interface element 414a (e.g., representation of the second user 414a), 420a, and/or 422a oriented towards a viewpoint of the user. For example, and as shown in FIG. 4H, overhead view 446 includes a first location of machine 404, a first location of the first user of the first electronic device 101, and a first position and/or orientation of the user interface element 414a such that the front-facing surface of the user interface element 414a faces toward the viewpoint of the user. It is understood that although the examples as will be described herein are directed to the user interface element 414a having the first position and/or orientation, such functions and/or characteristics, optionally apply to the other user interface elements, such as user interface elements 420a, and/or 422a in FIG. 4H.

In some examples, the first electronic device 101 detects movement of the viewpoint of the first user of the first electronic device 101. For example, in FIG. 4I, the first electronic device 101 detects movement of the first user of the first electronic device 101 from a first location 442 to a second location 444. In some examples, in response to detecting the movement, and in accordance with a determination that the first electronic device 101 is transmitting the portion of the three-dimensional environment according to a first mode (e.g., world-locked mode), the first electronic device 101 maintains the respective orientation of user interface element 414a as shown in overhead view 446 in FIG. 4I. For example, the first electronic device 101 does not change the respective orientations of user interface elements 414a, 420a, and 422a, such that the respective orientations of user interface elements 414a, 420a, and 422a continue to face the respective viewpoint of the user at the first location 442. In some examples, in response to detecting the movement of the first user of the first electronic device 101 from a first location 442 to a second location 444, and in accordance with a determination that the first electronic device 101 is transmitting the portion of the three-dimensional environment according to a second mode (e.g., lazy-follow mode), different from the mode, the first electronic device 101 presents user interface elements 414a, 420a, and 422a with respective orientations that are based on the movement of the viewpoint of the first user of the first electronic device as shown in FIG. 4J. For example, the first electronic device 101 changes the orientation and/or position of the user interface element 414a such that the front-facing surface of the user interface element 414a faces toward the viewpoint of the user as shown in the overhead view 446. Thus, in some examples, the first electronic device 101 changes the respective orientations of user interface element 412a, 420a, and 422a to face the viewpoint of the first user.

In some examples, the portion of the three-dimensional environment corresponding to the region that is transmitted to the second electronic device 101z to be presented by the second electronic device 101z, such as illustrated by user interface element 428 in FIG. 4E changes or does not change based on the movement of the first user of the first electronic device 101 to ensure a stable presentation. For example, while the first electronic device 101 transmits the portion of the three-dimensional environment corresponding to the region to the second electronic device 101z, and in response to detecting the movement of the first user of the first electronic device 101 from a first location 442 to a second location 444, and in accordance with a determination that the movement satisfies a movement difference threshold (e.g., 30, 40, 50, 60, 70, or 80 degrees), the first electronic device 101 forgoes transmitting, to the second electronic device 101z, a view of the portion of the three-dimensional environment corresponding to the region that is based on the movement of the viewpoint and presents, via one or more displays (e.g., display 120), a notification to recenter a field of view of the first user of the first electronic device 101. In some examples, in response to detecting the movement, and in accordance with a determination that the movement does not satisfy the movement difference threshold, the first electronic device 101 transmits, to the second electronic device 101z, the view of the portion of the three-dimensional environment corresponding to the region that is based on the movement of the viewpoint and forgoes presenting the notification to recenter the field of view of the first user. In some examples, in response to detecting the movement, and in accordance with a determination that the movement satisfies the movement difference threshold, the first electronic device 101 presents, to the second electronic device 101z, a previously transmitted portion of the three-dimensional environment corresponding to the region. In this example, presenting the previously transmitted portion of the three-dimensional environment provides a consistent and seamless viewing experience for the user. In some examples, in response to detecting the movement, the first electronic device 101 transmits, to the second electronic device 101z, the view of the portion of the three-dimensional environment corresponding to the region that is based on the movement of the viewpoint.

In some examples, the first electronic device 101 presents an indication of the location of the second user of the second electronic device 101z. For example, in FIG. 4K, the first electronic device 101 presents, via the one or more displays (e.g., display 120), a second representation of the second user 448 of the second electronic device 101z relative to the physical object (e.g., the machine 404). In some examples, the first electronic device 101 detects, via the one or more input devices, a user input. In some examples, the user input is similar to user input 432 or user input 414 (or optionally referred to as an air pinch gesture 414) as described above and corresponds to a request to present a portion of the three-dimensional environment 400z of the second electronic device 101z from the viewpoint of the second user of the second electronic device 101z. In some examples, in response to detecting the user input, the first electronic device 101 presents user interface element 450a that includes the portion of the three-dimensional environment 400z of the second electronic device 101z from the viewpoint of the second user of the second electronic device 101z, as shown in FIG. 4L. For example, the portion includes a backside 450b the three-dimensional model (e.g., representation 430a in FIG. 4G) and user interface element 450c corresponding to the user interface element 428 in FIG. 4G. In FIG. 4L, the user interface element 450c includes supplemental information 450d corresponding to the supplemental information 440 in FIG. 4G.

In some examples, the first electronic device 101 receives from the second electronic device 101z an indication of movement of the second user of the second electronic device 101z (e.g., similar to the movement of the first user of the first electronic device 101 described in FIGS. 4H and 4I above) relative to the three-dimensional model (e.g., representation 430a). In some examples, in response to receiving the indication of movement, the first electronic device 101 presents, in the three-dimensional environment 400 via one or more displays of the first electronic device (e.g., display 12), a representation of a location of the second user relative to a physical object that corresponds to the movement received at the second electronic device 101z, such as similar presenting the representation of the second user 448 of the second electronic device 101z.

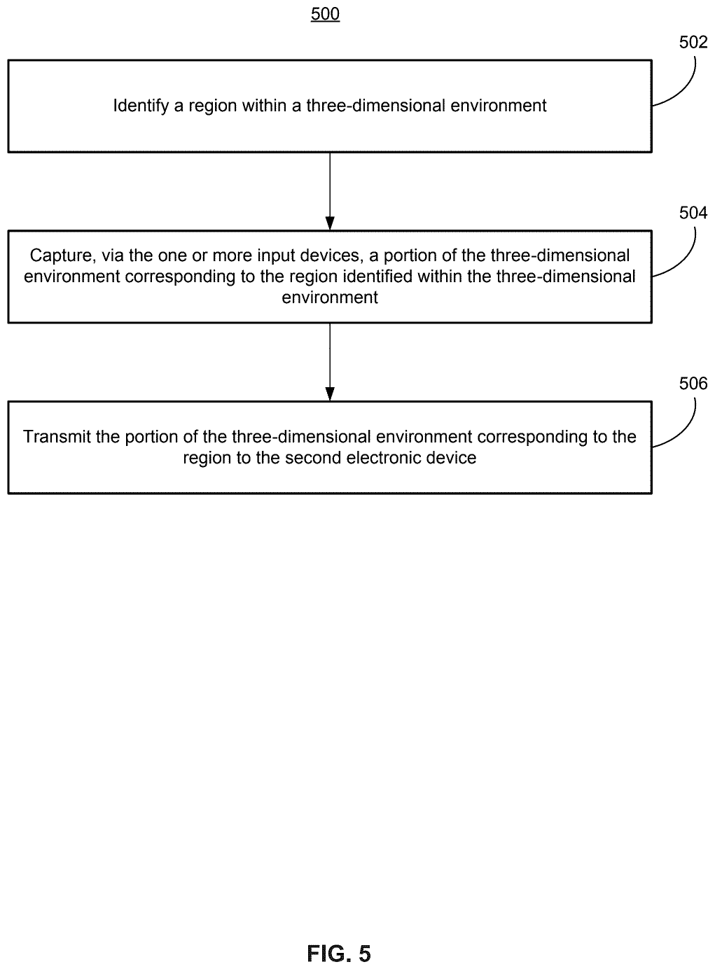

FIG. 5 illustrates a flow diagram illustrating an example process for transmitting a portion of a three-dimensional environment to an electronic device according to some examples of the disclosure. The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Performing an operation when a set of conditions has been met without requiring further user input (such as by transmitting a portion of a three-dimensional environment corresponding to a region to another electronic device) enhances the operability of the device by reducing unnecessary inputs and/or steps to navigate through different user interfaces or sets of controls, reducing energy usage by the device. Accordingly, the method 500 provides a technological improvement that results in minimizing the amount of data transmitted to and from devices, while also ensuring the most important and/or relevant data is prioritized. Additionally, when transmitting the potion of the three-dimensional environment, over, for example, a restricted bandwidth network, transmission times can be minimal due to reduced volume of data. Thus, process 500 provides savings in memory, bandwidth, processing, and time. Additionally, method 500 enhances AR/VR environments by improving stability and the visibility of real-world content while navigating within the physical space of the environment. Method 500 facilitates easier interaction with the environment, provides dynamic content enhancements, incorporates real-time adjustments to maintain the integrity of the AR/VR environment, and ensures a seamless user experience while the user moves within the physical space of the environment. In some examples, process 500 begins at a first electronic device (e.g., the first electronic device 101 in FIG. 4E) in communication with one or more input devices and a second electronic device (e.g., the second electronic device 101z in FIG. 1e). In some examples, the first electronic identifies (502) a region within a three-dimensional environment, such as, for example, the region within the three-dimensional environment 400 captured by user interface element 418a in FIG. 4D. In some examples, the first electronic device captures (504), via the one or more input devices, a portion of the three-dimensional environment corresponding to the region identified within the three-dimensional environment, such as discussed in method 300 in FIG. 3. In some examples, the first electronic device transmits (506) the portion of the three-dimensional environment corresponding to the region to the second electronic device, such as, for example, the portion illustrated via user interface element 428 presented by the second electronic device 101z in FIG. 4E.

It is understood that process 500 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising at a first electronic device in communication with and one or more input devices and a second electronic device: identifying a region within a three-dimensional environment; capturing, via the one or more input devices, a portion of the three-dimensional environment corresponding to the region identified within the three-dimensional environment; and transmitting the portion of the three-dimensional environment corresponding to the region to the second electronic device. Additionally or alternatively, the region includes a physical object. Additionally or alternatively, identifying the region within the three-dimensional environment includes presenting a representation of a two-dimensional bounding area or a three-dimensional bounding volume. Additionally or alternatively, identifying the region within the three-dimensional environment includes an input moving the representation of the two-dimensional bounding area or the three-dimensional bounding volume within the three-dimensional environment. Additionally or alternatively, identifying the region within the three-dimensional environment is based on one or more dimensions of a three-dimensional bounding region.

Additionally or alternatively, capturing the portion of the three-dimensional environment corresponding to the region includes generating a two-dimensional bounding area that is based on a current viewpoint of a first user of the first electronic device. Additionally or alternatively, capturing the portion of the three-dimensional environment corresponding to the region includes cropping a portion of a camera stream captured by the one or more input devices that is within the two-dimensional bounding area.

Additionally or alternatively, in some examples, the method further comprises: while transmitting the portion of the three-dimensional environment corresponding to the region to the second electronic device, detecting, via the one or more input devices, a movement of a viewpoint of a first user of the first electronic device. In some examples, in response to detecting the movement, and in accordance with a determination that the movement satisfies a movement difference threshold, the method further comprises: forgoing transmitting, to the second electronic device, a view of the portion of the three-dimensional environment corresponding to the region that is based on the movement of the viewpoint; and presenting, via one or more displays, a notification to recenter a field of view of the first user. In some examples, in response to detecting the movement, and in accordance with a determination that the movement does not satisfy the movement difference threshold, the method further comprises: transmitting, to the second electronic device, the view of the portion of the three-dimensional environment corresponding to the region that is based on the movement of the viewpoint; and forgoing presenting the notification to recenter the field of view of the first user.

Additionally or alternatively, in some examples, the method further comprises: in accordance with a determination that the movement satisfies the movement difference threshold, transmitting, to the second electronic device, a previously transmitted portion of the three-dimensional environment corresponding to the region. Additionally or alternatively, in some examples, the method further comprises: while transmitting the portion of the three-dimensional environment corresponding to the region to the second electronic device, detecting, via the one or more input devices, a movement of a viewpoint of a first user of the first electronic device; and in response to detecting the movement, transmitting, to the second electronic device, the view of the portion of the three-dimensional environment corresponding to the region that is based on the movement of the viewpoint. Additionally or alternatively, in some examples, the method further comprises: enhancing the portion of the three-dimensional environment corresponding to the region prior to transmitting the portion of the region to the second electronic device. Additionally or alternatively, in some examples, identifying the region within the three-dimensional environment includes capturing, via the one or more input devices, a coded image to identify a physical object. Additionally or alternatively, in some examples, identifying the region within the three-dimensional environment is based on an entire view of the environment or a partial view of the environment.

Additionally or alternatively, in some examples, the method further comprises: applying a visual treatment to a second portion of a camera stream captured by the one or more input devices, the second portion outside the portion of the three-dimensional environment corresponding to the region, prior to transmitting the portion of the region to the second electronic device; and transmitting the second portion of the three-dimensional environment to the second electronic device. Additionally or alternatively, in some examples, the method further comprises: presenting, via one or more displays of the first electronic device, a user interface element including a representation of a second user of the second electronic device with a first orientation in the three-dimensional environment that is based on a viewpoint of a first user of the first electronic device. In some examples, while presenting the user interface element, the method further comprises detecting, via the one or more input devices, a movement of the viewpoint of the first user; and in response to detecting the movement, and in accordance with a determination that the first electronic device is transmitting the portion of the three-dimensional environment according to a first mode, presenting the user interface element with a second orientation that is based on the movement of the viewpoint of the first user. In some examples, in response to detecting the movement, and in accordance with a determination that the first electronic device is transmitting the portion of the three-dimensional environment according to a second mode, different from the first mode, maintaining the first orientation of the user interface element.

Additionally or alternatively, in some examples, the method further comprises: transmitting a three-dimensional model corresponding to a physical object in the three-dimensional environment of the first electronic device to the second electronic device for concurrent presentation with the portion of the three-dimensional environment corresponding to the region via the second electronic device. Additionally or alternatively, in some examples, the method further comprises: receiving from the second electronic device an indication of an input received at the second electronic device; and presenting an annotation in the three-dimensional environment corresponding to the portion of the three-dimensional environment corresponding to the region or a physical object within the portion of the three-dimensional environment corresponding to the region, wherein the annotation corresponds to the input received at the second electronic device. Additionally or alternatively, in some examples, the method further comprises: receiving from the second electronic device an indication of movement of a second user of the second electronic device relative to a three-dimensional model; and presenting, in the three-dimensional environment via one or more displays of the first electronic device, a representation of a location of the second user relative to a physical object that corresponds to the movement received at the second electronic device.

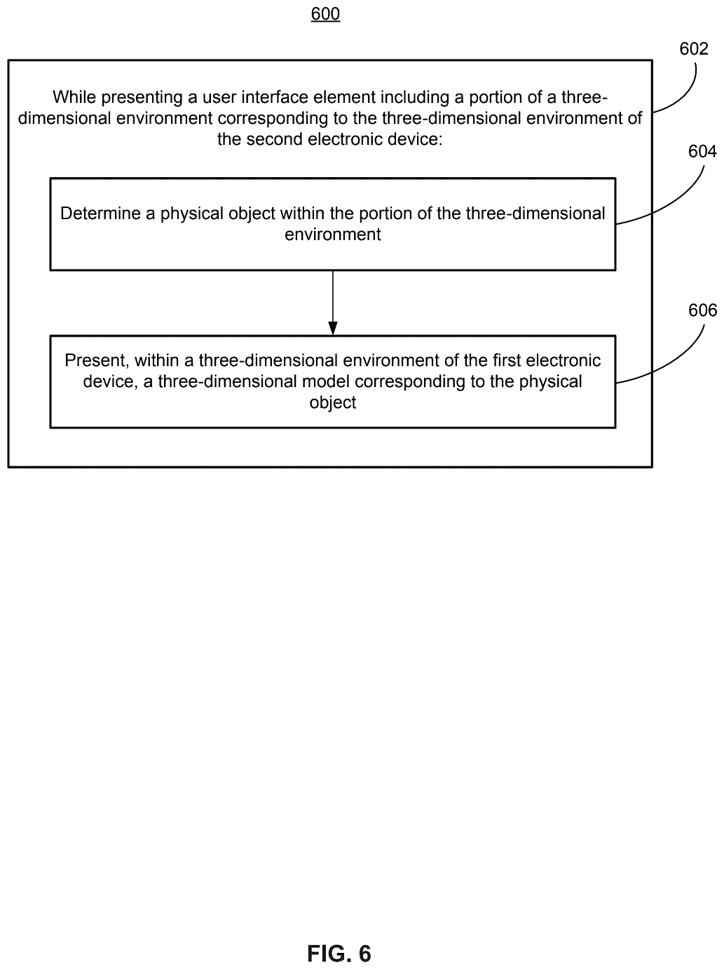

FIG. 6 illustrates a flow diagram illustrating an example process for presenting a virtual representation of a real-world object according to some examples of the disclosure. The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Performing an operation when a set of conditions has been met without requiring further user input (such as by presenting a three-dimensional model corresponding to a physical object within a three-dimensional environment) enhances the operability of the device by reducing unnecessary inputs and/or steps to navigate through different user interfaces or sets of controls, reducing energy usage by the device. Accordingly, the method 600 provides a technological improvement that results in providing additional control options (such as by presenting the three-dimensional model) without cluttering the UI with additional displayed controls enhances the operability of the device by reducing unnecessary inputs and/or steps to navigate through different user interfaces or sets of controls, reducing energy usage by the device. In some examples, process 600 begins at a first electronic device (e.g., the first electronic device 101 in FIG. 4E) in communication with one or more input devices and a second electronic device (e.g., the second electronic device 101z in FIG. 4E). In some examples, the first electronic identifies (502) a region within a three-dimensional environment, such the region presented via user interface element 428. In some examples, while presenting a user interface element including a portion of a three-dimensional environment corresponding to the three-dimensional environment of the second electronic device (602), the first electronic device determines (604) a physical object (e.g., machine 404 captured presented via the user interface element 428 in FIG. 4E) within the portion of the three-dimensional environment; and presents (606), within a three-dimensional environment of the first electronic device, a three-dimensional model corresponding to the physical object, such as the three-dimensional model (e.g., representation 430a) in FIG. 4E.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising at a first electronic device in communication with and one or more input devices and a second electronic device: while presenting a user interface element including a portion of a three-dimensional environment corresponding to the three-dimensional environment of the second electronic device: determining a physical object within the portion of the three-dimensional environment; and presenting, within a three-dimensional environment of the first electronic device, a three-dimensional model corresponding to the physical object. Additionally or alternatively, in some examples, the method further comprises: receiving from the second electronic device an indication of an input received at the second electronic device; and applying an annotation to the three-dimensional model, wherein the annotation corresponds to the input received at the second electronic device. Additionally or alternatively, in some examples, the method further comprises: presenting the three-dimensional model from a first viewpoint; while presenting the three-dimensional model from the first viewpoint, detecting, via the one or more input devices, an input; and in response to detecting the input, presenting the three-dimensional model from a second viewpoint, different from the first viewpoint. Additionally or alternatively, in some examples, the method further comprises: while presenting the three-dimensional model, presenting an indication of a location of the second electronic device relative to the three-dimensional model. Additionally or alternatively, in some examples, the method further comprises: while presenting the three-dimensional model, detecting, via the one or more input devices, an input; in response to detecting the input: applying an annotation to the three-dimensional model, wherein the annotation corresponds to the input; presenting, via the user interface element, the annotation in a region corresponding to the physical object; and initiating a process to cause the second electronic device to display a visual indication of the annotation.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some examples, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's biometric data.

The present disclosure recognizes that the use of such personal information data, in the present technology, can be used to the benefit of users. For example, personal information data may be used to display suggested text that changes based on changes in a user's biometric data. For example, the suggested text is updated based on changes to the user's age, height, weight, and/or health history.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method, comprising:
at a first electronic device in communication with one or more input devices and a second electronic device:
identifying a region within a three-dimensional environment;
capturing, via the one or more input devices, a portion of the three-dimensional environment corresponding to the region identified within the three-dimensional environment; and
transmitting the portion of the three-dimensional environment corresponding to the region to the second electronic device.

2. The method of claim 1, wherein identifying the region within the three-dimensional environment includes presenting a representation of a two-dimensional bounding area or a three-dimensional bounding volume.

3. The method of claim 1, wherein capturing the portion of the three-dimensional environment corresponding to the region includes generating a two-dimensional bounding area that is based on a current viewpoint of a first user of the first electronic device.

4. The method of claim 1, further comprising:
while transmitting the portion of the three-dimensional environment corresponding to the region to the second electronic device, detecting, via the one or more input devices, a movement of a viewpoint of a first user of the first electronic device; and
in response to detecting the movement:
in accordance with a determination that the movement satisfies a movement difference threshold:
forgoing transmitting, to the second electronic device, a view of the portion of the three-dimensional environment corresponding to the region that is based on the movement of the viewpoint; and
presenting, via one or more displays, a notification to recenter a field of view of the first user; and
in accordance with a determination that the movement does not satisfy the movement difference threshold:
transmitting, to the second electronic device, the view of the portion of the three-dimensional environment corresponding to the region that is based on the movement of the viewpoint; and
forgoing presenting the notification to recenter the field of view of the first user.

5. The method of claim 1, further comprising:
applying a visual treatment to a second portion of a camera stream captured by the one or more input devices, the second portion outside the portion of the three-dimensional environment corresponding to the region, prior to transmitting the portion of the region to the second electronic device; and
transmitting the second portion of the three-dimensional environment with the visual treatment applied to the second electronic device.

6. The method of claim 5, further comprising:
presenting, via one or more displays of the first electronic device, a user interface element including a representation of a second user of the second electronic device with a first orientation in the three-dimensional environment that is based on a viewpoint of a first user of the first electronic device;
while presenting the user interface element, detecting, via the one or more input devices, a movement of the viewpoint of the first user; and
in response to detecting the movement:
in accordance with a determination that the first electronic device is transmitting the portion of the three-dimensional environment according to a first mode, presenting the user interface element with a second orientation that is based on the movement of the viewpoint of the first user; and
in accordance with a determination that the first electronic device is transmitting the portion of the three-dimensional environment according to a second mode, different from the first mode, maintaining the first orientation of the user interface element.

7. The method of claim 1, further comprising:
transmitting a three-dimensional model corresponding to a physical object in the three-dimensional environment of the first electronic device to the second electronic device for concurrent presentation with the portion of the three-dimensional environment corresponding to the region via the second electronic device.

8. The method of claim 1, further comprising:
receiving from the second electronic device an indication of movement of a second user of the second electronic device relative to a three-dimensional model; and
presenting, in the three-dimensional environment via one or more displays of the first electronic device, a representation of a location of the second user relative to a physical object that corresponds to the movement received at the second electronic device.

9. A first electronic device comprising:
one or more processors;
memory; and
one or more programs stored in the memory and configured to be executed by the one or more processors, the one or more programs including instructions for:
identifying a region within a three-dimensional environment;
capturing, via one or more input devices, a portion of the three-dimensional environment corresponding to the region identified within the three-dimensional environment; and
transmitting the portion of the three-dimensional environment corresponding to the region to a second electronic device.

10. The first electronic device of claim 9, wherein identifying the region within the three-dimensional environment includes presenting a representation of a two-dimensional bounding area or a three-dimensional bounding volume.

11. The first electronic device of claim 9, wherein capturing the portion of the three-dimensional environment corresponding to the region includes generating a two-dimensional bounding area that is based on a current viewpoint of a first user of the first electronic device.

12. The first electronic device of claim 9, wherein the one or more programs further include instructions for:
while transmitting the portion of the three-dimensional environment corresponding to the region to the second electronic device, detecting, via the one or more input devices, a movement of a viewpoint of a first user of the first electronic device; and
in response to detecting the movement:
in accordance with a determination that the movement satisfies a movement difference threshold:
forgoing transmitting, to the second electronic device, a view of the portion of the three-dimensional environment corresponding to the region that is based on the movement of the viewpoint; and
presenting, via one or more displays, a notification to recenter a field of view of the first user; and
in accordance with a determination that the movement does not satisfy the movement difference threshold:
transmitting, to the second electronic device, the view of the portion of the three-dimensional environment corresponding to the region that is based on the movement of the viewpoint; and
forgoing presenting the notification to recenter the field of view of the first user.

13. The first electronic device of claim 9, wherein the one or more programs further include instructions for:
applying a visual treatment to a second portion of a camera stream captured by the one or more input devices, the second portion outside the portion of the three-dimensional environment corresponding to the region, prior to transmitting the portion of the region to the second electronic device; and
transmitting the second portion of the three-dimensional environment with the visual treatment applied to the second electronic device.

14. The first electronic device of claim 13, wherein the one or more programs further include instructions for:
presenting, via one or more displays of the first electronic device, a user interface element including a representation of a second user of the second electronic device with a first orientation in the three-dimensional environment that is based on a viewpoint of a first user of the first electronic device;
while presenting the user interface element, detecting, via the one or more input devices, a movement of the viewpoint of the first user; and
in response to detecting the movement:
in accordance with a determination that the first electronic device is transmitting the portion of the three-dimensional environment according to a first mode, presenting the user interface element with a second orientation that is based on the movement of the viewpoint of the first user; and
in accordance with a determination that the first electronic device is transmitting the portion of the three-dimensional environment according to a second mode, different from the first mode, maintaining the first orientation of the user interface element.

15. The first electronic device of claim 9, wherein the one or more programs further include instructions for:
transmitting a three-dimensional model corresponding to a physical object in the three-dimensional environment of the first electronic device to the second electronic device for concurrent presentation with the portion of the three-dimensional environment corresponding to the region via the second electronic device.

16. The first electronic device of claim 9, wherein the one or more programs further include instructions for:
receiving from the second electronic device an indication of movement of a second user of the second electronic device relative to a three-dimensional model; and
presenting, in the three-dimensional environment via one or more displays of the first electronic device, a representation of a location of the second user relative to a physical object that corresponds to the movement received at the second electronic device.

17. A non-transitory computer readable storage medium storing one or more programs, the one or more programs comprising instructions, which when executed by one or more processors of a first electronic device, cause the first electronic device to:
identify a region within a three-dimensional environment;
capture, via one or more input devices, a portion of the three-dimensional environment corresponding to the region identified within the three-dimensional environment; and
transmit the portion of the three-dimensional environment corresponding to the region to a second electronic device.

18. The non-transitory computer readable storage medium of claim 17, wherein identifying the region within the three-dimensional environment includes presenting a representation of a two-dimensional bounding area or a three-dimensional bounding volume.

19. The non-transitory computer readable storage medium of claim 17, wherein capturing the portion of the three-dimensional environment corresponding to the region includes generating a two-dimensional bounding area that is based on a current viewpoint of a first user of the first electronic device.

20. The non-transitory computer readable storage medium of claim 17, wherein the one or more programs further cause the first electronic device to:
while transmitting the portion of the three-dimensional environment corresponding to the region to the second electronic device, detect, via the one or more input devices, a movement of a viewpoint of a first user of the first electronic device; and
in response to detecting the movement:
in accordance with a determination that the movement satisfies a movement difference threshold:
forgo transmitting, to the second electronic device, a view of the portion of the three-dimensional environment corresponding to the region that is based on the movement of the viewpoint; and
present, via one or more displays, a notification to recenter a field of view of the first user; and
in accordance with a determination that the movement does not satisfy the movement difference threshold:
transmit, to the second electronic device, the view of the portion of the three-dimensional environment corresponding to the region that is based on the movement of the viewpoint; and
forgo presenting the notification to recenter the field of view of the first user.

21. The non-transitory computer readable storage medium of claim 17, wherein the one or more programs further cause the first electronic device to:
apply a visual treatment to a second portion of a camera stream captured by the one or more input devices, the second portion outside the portion of the three-dimensional environment corresponding to the region, prior to transmitting the portion of the region to the second electronic device; and
transmit the second portion of the three-dimensional environment with the visual treatment applied to the second electronic device.

22. The non-transitory computer readable storage medium of claim 21, wherein the one or more programs further cause the first electronic device to:
present, via one or more displays of the first electronic device, a user interface element including a representation of a second user of the second electronic device with a first orientation in the three-dimensional environment that is based on a viewpoint of a first user of the first electronic device;
while presenting the user interface element, detect, via the one or more input devices, a movement of the viewpoint of the first user; and
in response to detecting the movement:
in accordance with a determination that the first electronic device is transmitting the portion of the three-dimensional environment according to a first mode, present the user interface element with a second orientation that is based on the movement of the viewpoint of the first user; and
in accordance with a determination that the first electronic device is transmitting the portion of the three-dimensional environment according to a second mode, different from the first mode, maintain the first orientation of the user interface element.

23. The non-transitory computer readable storage medium of claim 17, wherein the one or more programs further cause the first electronic device to:
transmit a three-dimensional model corresponding to a physical object in the three-dimensional environment of the first electronic device to the second electronic device for concurrent presentation with the portion of the three-dimensional environment corresponding to the region via the second electronic device.

24. The non-transitory computer readable storage medium of claim 17, wherein the one or more programs further cause the first electronic device to:
receive from the second electronic device an indication of movement of a second user of the second electronic device relative to a three-dimensional model; and
presenting, in the three-dimensional environment via one or more displays of the first electronic device, a representation of a location of the second user relative to a physical object that corresponds to the movement received at the second electronic device.
